(19) United States
(12) Patent Application Publication
(10) Pub. No.: US 2021/0168763 A1
(43) Pub. Date: Jun. 3, 2021

(54) COMMUNICATION DEVICE THAT SUPPORTS D2D COMMUNICATION, BASE STATION DEVICE, AND COMMUNICATION METHOD

(71) Applicant: FUJITSU LIMITED, Kawasaki-shi (JP)

(72) Inventors: Huiting Cheng, Yokohama (JP); Jianming Wu, Kawasaki (JP); Hongyang CHEN, Kawasaki (JP)

(73) Assignee: FUJITSU LIMITED, Kawasaki-shi (JP)

(21) Appl. No.: 17/167,138

(22) Filed: Feb. 4, 2021

Related U.S. Application Data
(63) Continuation of application No. PCT/JP2018/029980, filed on Aug. 9, 2018.

(51) Int. Cl. H04W 72/02; H04W 72/04; H04W 4/70; H04W 4/40

(52) U.S. Cl. CPC H04W 72/02; H04W 72/0406; H04W 72/0453; H04W 4/40; H04W 72/0446; H04W 4/70

(57) ABSTRACT

A communication device supports device-to-device (D2D) communication and includes a processor, a transmitter, and a receiver. The processor generates control information that pertains to D2D data and requests a resource for transmitting the D2D data. The transmitter transmits the control information to a base station. The receiver receives, from the base station, information indicating resource allocation for transmitting the D2D data via D2D communication. The transmitter transmits the D2D data to a destination device via D2D communication according to the information indicating the resource allocation.

### CROSS-REFERENCE TO RELATED APPLICATION

This application is a continuation application of International Application PCT/JP2018/029980 filed on Aug. 9, 2018 and designated the U.S., the entire contents of which are incorporated herein by reference.

### FIELD

The embodiments discussed herein are related to a communication device that supports D2D communication, a base station device, a communication system that includes the communication device and the base station device, and a method for communication between the communication device and the base station device.

### BACKGROUND

Recently, many network resources are occupied by traffic used by mobile terminals (including smartphones or feature phones). Traffic to be used by mobile terminals is considered to increase in the future as well.

Meanwhile, with the development of Internet-of-things (IoT) services (e.g., traffic systems, smart meters, monitoring services for devices and the like), services with various required conditions need to be addressed. Accordingly, communication standards for the fifth-generation mobile communication (5G (NR: New Radio)) need to attain techniques for implementing the standard techniques of the fourth-generation mobile communication (4G (LTE: Long Term Evolution)) (e.g., documents 1-12) as well as higher data rates, larger capacities, and lower latencies. The 3GPP working groups (e.g., TSG-RAN WG1, TSG-RAN WG2) have studied standards for the fifth-generation communication (e.g., documents 13-38).

With respect to 5G, supports have been considered for use cases classified as Enhanced Mobile BroadBand (eMBB), Machine Type Communications (Massive MTC), and Ultra-Reliable and Low Latency Communication (URLLC) in order to address a wide variety of services.

The 3GPP working groups have also discussed device-to-device (D2D) communication. D2D communication may also be referred to as sidelink communication. V2X has been studied as an example of D2D communication. V2X includes V2V, V2P, and V2I. V2V indicates vehicle-to-vehicle communication. V2P indicates communication between vehicles and pedestrians. V2I indicates communication between vehicles and roadside infrastructures such as signs. Regulations pertaining to V2X are described in, for example, document 39. In the meantime, concentrated resource allocation (In-coverage RRC_CONNECTED UEs) and distributed resource allocation (In-coverage RRC_IDLE UEs or out-of-coverage UEs) are defined for the V2X of 4G.

### Prior Art Documents

### Document 1: 3GPP TS 36.211 V15.1.0 (2018-03)

### Document 2: 3GPP TS 36.212 V15.1.0 (2018-03)

### Document 3: 3GPP TS 36.213 V15.1.0 (2018-03)

### Document 4: 3GPP TS 36.300 V15.1.0 (2018-03)

### Document 5: 3GPP TS 36.321 V15.1.0 (2018-03)

### Document 6: 3GPP TS 36.322 V15.0.1 (2018-04)

### Document 7: 3GPP TS 36.323 V14.5.0 (2017-12)

### Document 8: 3GPP TS 36.331 V15.1.0 (2018-03)

### Document 9: 3GPP TS 36.413 V15.1.0 (2018-03)

### Document 10: 3GPP TS 36.423 V15.1.0 (2018-03)

### Document 11: 3GPP TS 36.425 V14.1.0 (2018-03)

### Document 12: 3GPP TS 37.340 V15.1.0 (2018-03)

### Document 13: 3GPP TS 38.201 V15.0.0 (2017-12)

### Document 14: 3GPP TS 38.202 V15.1.0 (2018-03)

### Document 15: 3GPP TS 38.211 V15.1.0 (2018-03)

### Document 16: 3GPP TS 38.212 V15.1.1 (2018-04)

### Document 17: 3GPP TS 38.213 V15.1.0 (2018-03)

### Document 18: 3GPP TS 38.214 V15.1.0 (2018-03)

### Document 19: 3GPP TS 38.215 V15.1.0 (2018-03)

### Document 20: 3GPP TS 38.300 V15.1.0 (2018-03)

### Document 21: 3GPP TS 38.321 V15.1.0 (2018-03)

### Document 22: 3GPP TS 38.322 V15.1.0 (2018-03)

### Document 23: 3GPP TS 38.323 V15.1.0 (2018-03)

### Document 24: 3GPP TS 38.331 V15.1.0 (2018-03)

### Document 25: 3GPP TS 38.401 V15.1.0 (2018-03)

### Document 26: 3GPP TS 38.410 V0.9.0 (2018-04)

### Document 27: 3GPP TS 38.413 V0.8.0 (2018-04)

### Document 28: 3GPP TS 38.420 V0.8.0 (2018-04)

### Document 29: 3GPP TS 38.423 V0.8.0 (2018-04)

### Document 30: 3GPP TS 38.470 V15.1.0 (2018-03)

### Document 31: 3GPP TS 38.473 V15.1.1 (2018-04)

### Document 32: 3GPP TR 38.801 V14.0.0 (2017-04)

### Document 33: 3GPP TR 38.802 V14.2.0 (2017-09)

### Document 34: 3GPP TR 38.803 V14.2.0 (2017-09)

### Document 35: 3GPP TR 38.804 V14.0.0 (2017-03)

### Document 36: 3GPP TR 38.900 V14.3.1 (2017-07)

### Document 37: 3GPP TR 38.912 V14.1.0 (2017-06)

### Document 38: 3GPP TR 38.913 V14.3.0 (2017-06)

### Document 39: 3GPP TS 22.186 V15.2.0 (2017-09)

In 5G system, low-latency D2D communication may be requested depending on a use case. However, no procedures have been determined for implementing low-latency D2D communication. For example, no procedures for resource allocation for V2X communication have been determined.

### SUMMARY

According to an aspect of the present invention, a communication device supports device-to-device (D2D) communication. The communication device includes: a processor configured to generate control information that pertains to D2D data and requests a resource for transmitting the D2D data; a transmitter configured to transmit the control information to a base station; and a receiver configured to receive, from the base station, information indicating resource allocation for transmitting the D2D data via D2D communication. The transmitter transmits the D2D data to a destination device via D2D communication according to the information indicating the resource allocation.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1A illustrates an example of a wireless communication system;

FIG. 1B illustrates an example of resource allocation for sidelink communication;

FIG. 2 illustrates an example of resource allocation according to 4G (LTE);

FIG. 3 indicates latency in a procedure depicted in FIG. 2;

FIG. 4 illustrates an example of a case in which 4G resource allocation is performed in a 5G wireless communication system;

FIG. 5 indicates latency in a procedure depicted in FIG. 4;

FIG. 6 illustrates an example of the configuration of a base station;

FIG. 7A illustrates an example of a wireless communication device;

FIG. 7B illustrates another example of a wireless communication device;

FIG. 8 illustrates an example of a sequence of V2X communication;

FIG. 9 illustrates an example of relations between sidelink control information and attributes of V2X traffic/services;

FIG. 10 is a flowchart illustrating an example of processes performed by a VUE;

FIG. 11 is a flowchart illustrating an example of processes performed by a base station;

FIG. 12 illustrates an example of resource allocation in a first embodiment;

FIG. 13 indicates latency in a procedure depicted in FIG. 12;

FIGS. 14A, 14B, 15A, and 15B illustrate examples of cases in which a plurality of VUEs each request sidelink communication;

FIG. 16 is a flowchart illustrating an example of processes performed by a VUE in a second embodiment;

FIG. 17 is a flowchart illustrating an example of processes performed by a base station in a second embodiment;

FIG. 18 illustrates an example of resource allocation in a third embodiment; and

FIG. 19 indicates latency in a procedure depicted in FIG. 18.

### DESCRIPTION OF EMBODIMENTS

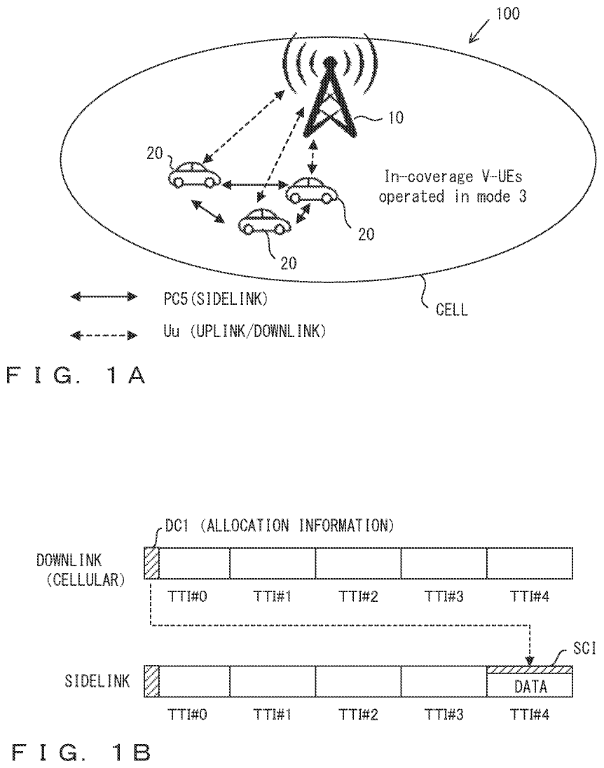

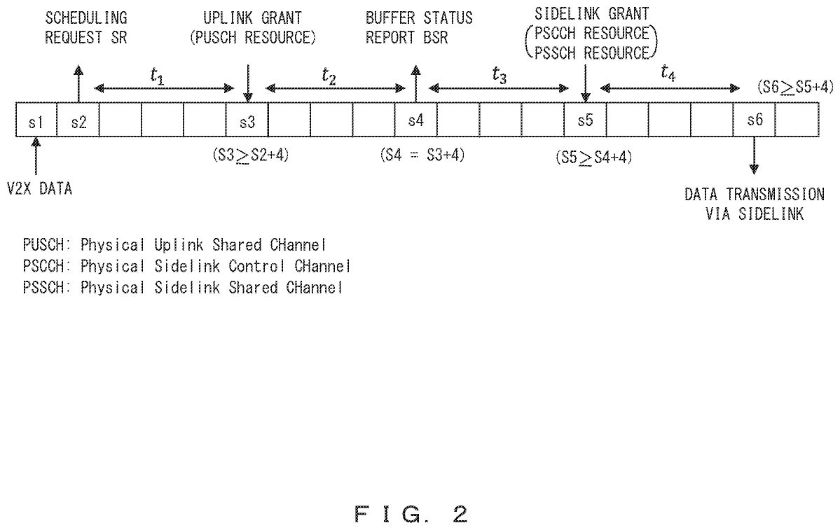

FIG. 1A illustrates an example of a wireless communication system in accordance with embodiments of the invention. As depicted in FIG. 1A, a wireless communication system 100 includes a base station 10 and a plurality of wireless communication devices 20. In this example, each of the wireless communication devices 20 is equipped in a vehicle.

The base station 10 controls cellular communication performed by the wireless communication devices 20 (uplink/downlink communication performed via Uu interfaces). Thus, the base station 10 receives uplink signals (control signals and data signals) from the wireless communication devices 20. Meanwhile, the base station 10 transmits downlink signals (control signals and data signals) to the wireless communication devices 20.

The wireless communication device 20 can communicate with another communication device via the base station 10. The wireless communication device 20 can also communicate with another wireless communication device without the intervention of the base station 10. That is, the wireless communication device 20 supports Device-to-Device (D2D) communication. In D2D communication, a signal may be transmitted via a PC5 interface. D2D communication may also be referred to as “sidelink communication.” The wireless communication device 20 may also be referred to as a “user equipment (UE)” or “vehicle UE (VUE).”

As described above, the wireless communication devices 20 are each equipped in a vehicle. Thus, in this example, the wireless communication devices 20 can perform V2X communication. V2X includes V2V, V2P, and V2I. V2V indicates vehicle-to-vehicle communication. V2P indicates communication between vehicles and pedestrians. V2I indicates communication between vehicles and roadside infrastructures such as signs.

In this example, the base station 10 controls allocation of resources for sidelink communication. The following descriptions are based on the assumption that resource allocation for sidelink communication is controlled in accordance with the scheduled resource allocation mode (sidelink transmission mode3). In this case, a wireless communication device 20 makes a request for the base station 10 to provide this device with resources for sidelink communication. The base station 10 performs the requested resource allocation for implementing sidelink communication. In the example depicted in FIG. 1B, a time slot #4 is allocated to V2X communication. The resources allocated to V2X communication include resources for transmitting V2X data and resources for transmitting control information SCI for V2X data. Control information SCI indicates subcarriers, symbols, modulation scheme, code, and the like for transmitting V2X data. This resource allocation implements a sidelink communication for the in-coverage RRC_CONNECTED V-UEs. Resource allocation methods for sidelink communication are described in, for example, 3GPP TS 36.300 and 3GPP TS 36.213.

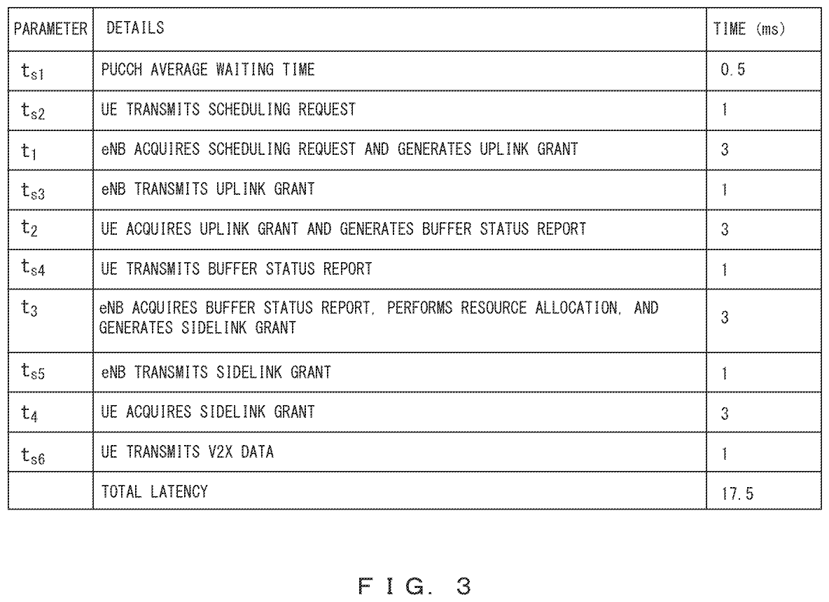

FIG. 2 illustrates an example of resource allocation according to 4G (LTE). In this example, a wireless communication device 20 makes a request for the base station 10 to provide this device with resources for transmitting V2X data via sidelink communication. The resource allocation is performed in the scheduled resource allocation mode (sidelink transmission mode3). Note that the length of each subframe in 4G is 1 millisecond.

At a subframe s1, V2X data is generated by an application of the wireless communication device 20. In this case, at a subframe s2, the wireless communication device 20 transmits a scheduling request (SR) to the base station 10. The scheduling request SR requests resources for uplink.

The base station 10 generates an uplink grant in response to the scheduling request. The uplink grant includes information indicating resources for a physical uplink shared channel (PUSCH). At a subframe s3, the base station 10 transmits the uplink grant to the wireless communication device 20.

The wireless communication device 20 transmits a sidelink buffer status report (sidelink BSR) to the base station 10 by using resources reported by the uplink grant. In this example, at a subframe s4, the sidelink buffer status report BSR is transmitted using the PUSCH. The sidelink buffer status report BSR indicates the amount of V2X data stored in a buffer memory of the wireless communication device 20.

The base station 10 determines resources for V2X communication according to the sidelink buffer status report BSR. In particular, resources for a physical sidelink control channel (PSCCH) and resources for a physical sidelink shared channel (PSSCH) are determined. The resources for the PSCCH are allocated to a control signal for controlling V2X communication. The resources for the PSSCH are allocated to V2X data. At a subframe s5, the base station 10 transmits a sidelink grant to the wireless communication device 20. The sidelink grant includes information indicating the PSCCH resources and the PSSCH resources.

The wireless communication device 20 transmits V2X data to a destination device by using the resources reported by the sidelink grant. In this example, V2X data is transmitted at a subframe s6.

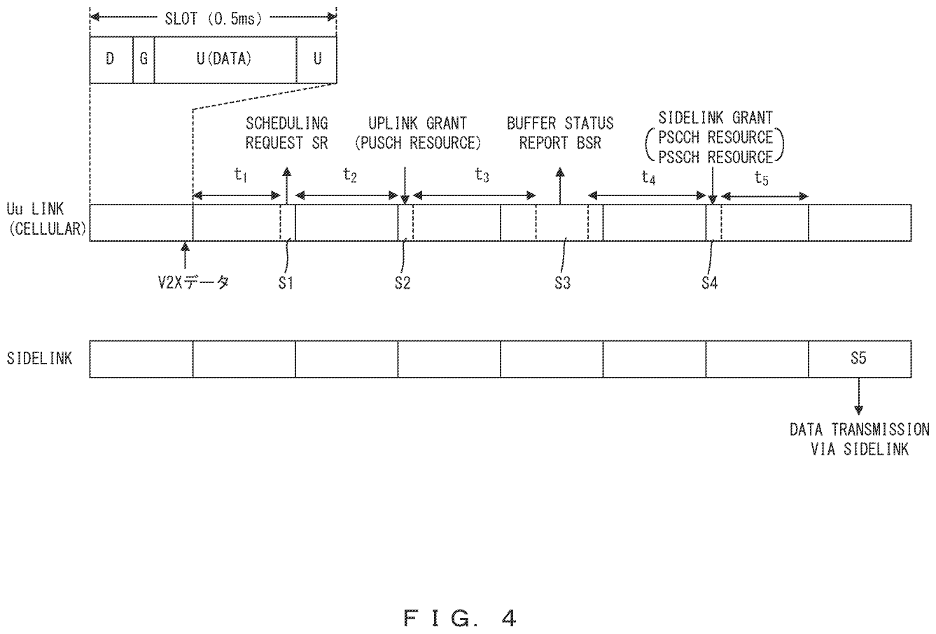

In the procedure depicted in FIG. 2, the time period from the moment at which V2X data is generated to the moment at which the V2X data is transmitted (i.e., latency or delay) corresponds to the sum of t₁-t₄ and tₛ₁-tₛ₆ depicted in FIG. 3. Thus, in 4G (LTE) system, a latency pertaining to the transmission of V2X data may be about 17.5 milliseconds.

Various use cases pertaining to V2X communication are defined for 5G (NR: New Radio). In particular, V2X services include the following four types of use.

(1) Vehicle platooning
(2) Advanced driving
(3) Extended sensors
(4) Remote driving
The vehicle platooning allows a plurality of vehicles to travel in a column. The advanced driving allows for semi-automatic driving or full automatic driving. The extended sensors allow for exchange of data output from sensors equipped in vehicles, roadside units (RSUs), or devices held by a pedestrians or exchange of live video data of V2X application servers. The remote driving allows a vehicle to be driven by a driver in a remote location or to be driven according to V2X applications.

Depending on a use case, a very small latency may be needed. For example, in some applications for the advanced driving or the extended sensors, a maximum end-to-end latency of 3 milliseconds may be needed.

However, 5G has no procedures determined yet for resource allocation in V2X communication. Accordingly, consideration is given to a case in which the procedures for 4G depicted in FIG. 2 are applied to the V2X communication according to 5G.

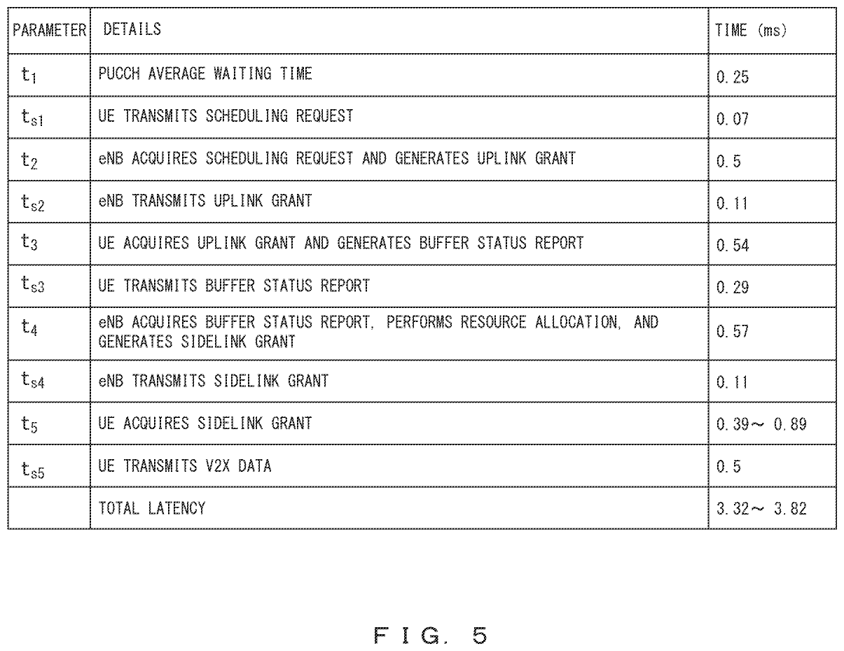

FIG. 4 illustrates an example of a case in which 4G resource allocation is performed in a 5G wireless communication system. In this example, the resource allocation is performed in the scheduled resource allocation mode (mode3).

The length of each slot is 0.5 milliseconds. The time domain of each slot is formed from 14 symbols. In the example depicted in FIG. 4, three symbols are allocated to a downlink (data and control information). Eight symbols are allocated to an uplink (data). Two symbols are allocated to an uplink (control information). Furthermore, one symbol of guard section is provided.

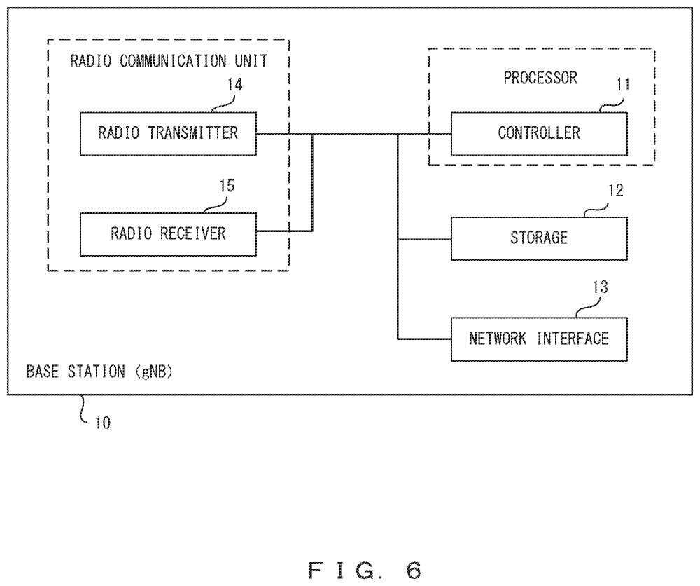

In this case, the time period from the moment at which V2X data is generated to the moment at which the V2X data is transmitted (i.e., latency) corresponds to the sum of t₁-t₅ and tₛ₁-tₛ₅ depicted in FIG. 5. Thus, a latency pertaining to the transmission of V2X data is estimated to be 3.32-3.82 milliseconds. Accordingly, when the 4G (LTE) resource allocation procedure is simply applied to the 5G (NR) wireless communication system, requirements pertaining to a latency in 5G V2X services are not always satisfied.

### First Embodiment

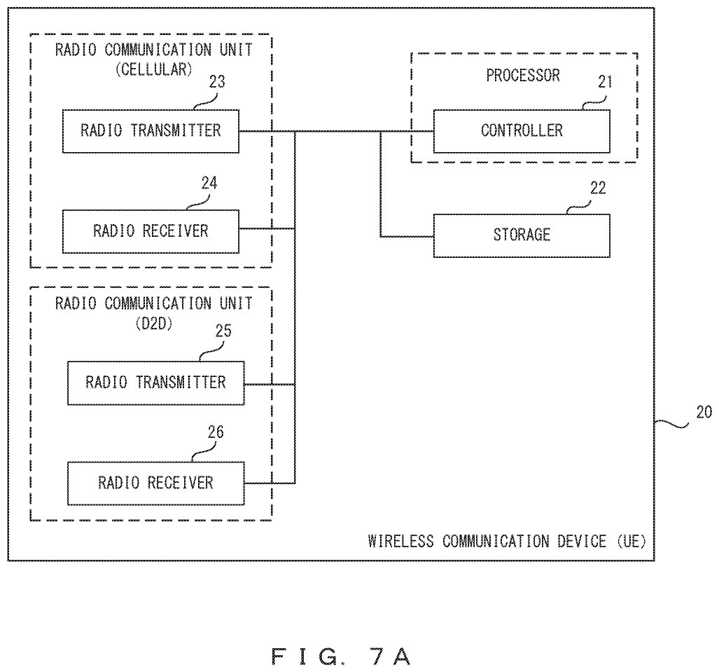

FIG. 6 illustrates an example of the configuration of a base station. For example, a base station 10 may be a next generation base station device (gNB: Next generation Node B). As depicted in FIG. 6, the base station 10 includes a controller 11, a storage 12, a network interface 13, a radio transmitter 14, and a radio receiver 15. Note that the base station 10 may include other circuits or functions that are not depicted in FIG. 6.

The controller 11 controls cellular communication provided by the base station 10. The controller 11 can allocate resources to D2D communication (i.e., sidelink communication) performed by wireless communication devices 20. In this example, the controller 11 is implemented by a processor. In this case, the controller 11 executes a software program stored in the storage so as to provide a function for controlling cellular communication and a function for allocating resources to D2D communication. However, some of the functions of the controller 11 may be implemented by a hardware circuit.

The storage 12 stores a software program to be executed by a processor. The storage 12 also stores data needed to control operations of the base station 10. For example, the storage 12 may be implemented by a semiconductor memory. The network interface 13 provides an interface for connecting to a core network. Accordingly, the base station 10 can be connected via the network interface 13 to another base station 10 or a network management system for controlling the base station 10.

The radio transmitter 14 transmits radio signals for cellular communication in accordance with an instruction from the controller 11. Thus, the radio transmitter 14 transmits downlink signals to the wireless communication devices 20 within the cell. The radio receiver 15 receives radio signals for cellular communication in accordance with an instruction from the controller 11. Thus, the radio receiver 15 receives uplink signals transmitted from the wireless communication devices 20 within the cell. For example, cellular communication may be provided using a 2.4 GHz band and/or 4 GHz band.

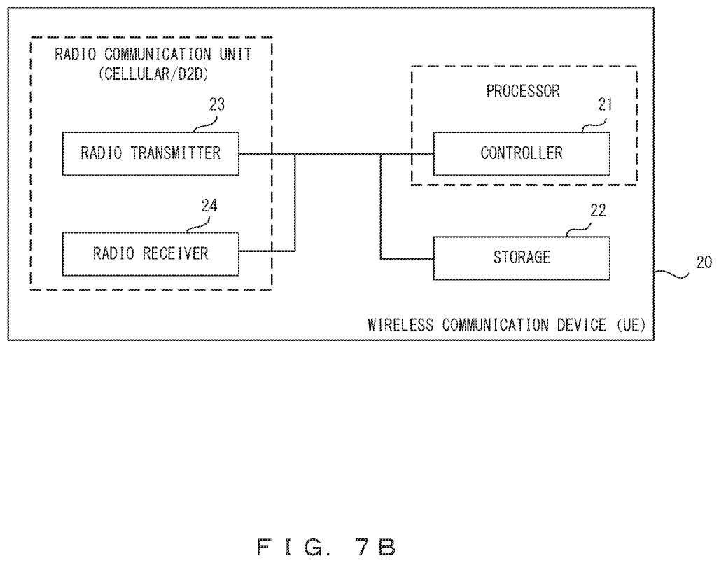

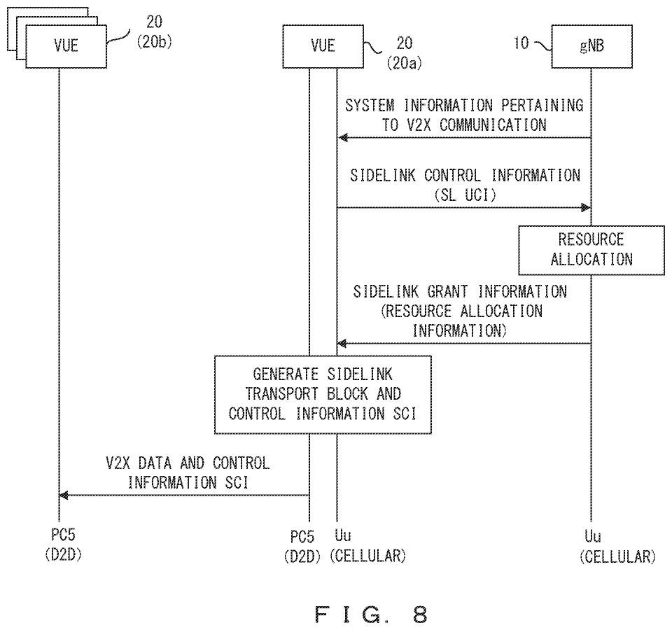

FIG. 7A illustrates an example of a wireless communication device. A wireless communication device 20 supports cellular communication and D2D communication. D2D communication is implemented using a different frequency band from cellular communication. For example, D2D communication may be provided using a 6 GHz band. However, D2D communication may use the same frequency band as the uplink in cellular communication. The wireless communication device 20 includes a controller 21, a storage 22, a radio transmitter 23, a radio receiver 24, a radio transmitter 25, and a radio receiver 26. Note that the wireless communication device 20 may include other circuits or functions that are not depicted in FIG. 7A.

In the example depicted in FIG. 7A, the radio communication unit for cellular communication and the radio communication unit for D2D communication are provided separately from each other. However, the wireless communication device 20 is not limited to this configuration. For example, as depicted in FIG. 7B, one radio communication unit may be shared by cellular communication and D2D communication. In this case, the radio transmitter 23 transmits cellular signals and D2D signals, and the radio receiver 24 receives cellular signals and D2D signals.

The controller 21 controls cellular communication and D2D communication provided by the wireless communication device 20. In this example, the controller 21 is implemented by a processor. In this case, the controller 21 executes a software program stored in the storage 22 so as to provide a function for controlling cellular communication and D2D communication. However, some of the functions of the controller 21 may be implemented by a hardware circuit.

The storage 22 stores a software program to be executed by a processor. The storage 22 also stores data and information needed to control operations of the wireless communication device 20. For example, the storage 22 may be implemented by a semiconductor memory.

The radio transmitter 23 transmits a radio signal for cellular communication in accordance with an instruction from the controller 21. Thus, the radio transmitter 23 transmits an uplink signal to the base station 10. The radio receiver 24 receives a radio signal for cellular communication in accordance with an instruction from the controller 21. Thus, the radio receiver 24 receives a downlink signal transmitted from the base station 10.

The radio transmitter 25 transmits a radio signal for D2D communication in accordance with an instruction from the controller 21. Thus, the radio transmitter 25 transmits a D2D signal to another wireless communication device by using resources allocated by the base station 10. The radio receiver 26 receives a radio signal for D2D communication in accordance with an instruction from the controller 21. Thus, the radio receiver 26 receives a D2D signal transmitted from another wireless communication device. In this example, a D2D signal includes V2X data and V2X data control information.

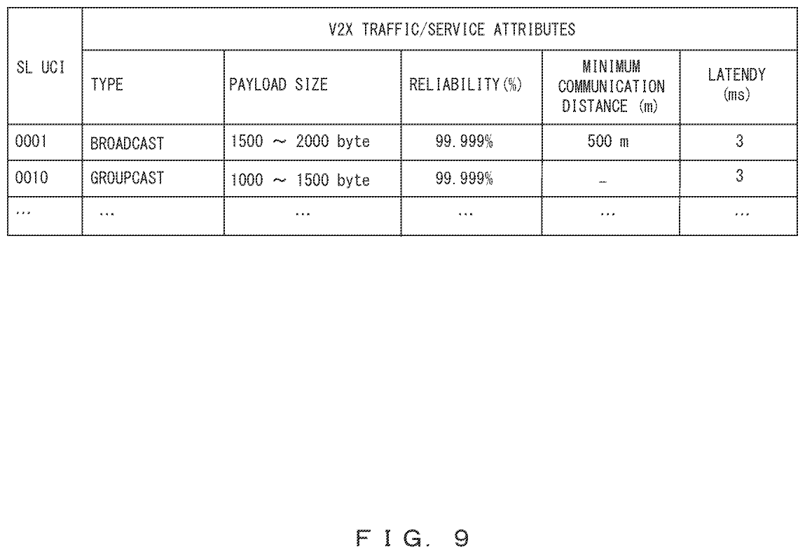

FIG. 8 illustrates an example of a sequence of V2X communication. In this example, a wireless communication system includes a base station (gNB) 10 and a plurality of wireless communication devices (VUEs) 20. A VUE 20a transmits data to a VUE 20b via V2X communication. Alternatively, the VUE 20a may transmit data to a plurality of VUEs 20, including the VUE 20b, via V2X communication. At least the VUE 20a of the plurality of VUEs 20 is located within a cell covered by the base station 10. The VUE 20a is implemented in a vehicle. The other VUEs 20a may be implemented in vehicles, held by pedestrians, or incorporated into roadside infrastructures.

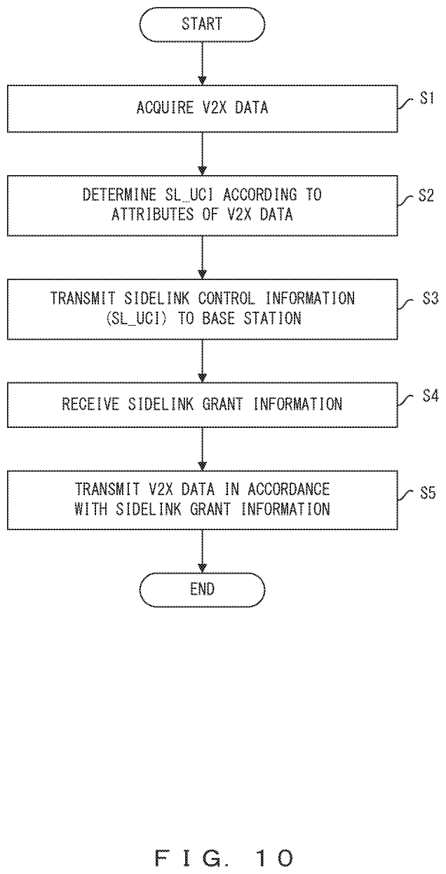

Although not indicated in FIG. 8, the VUE 20a transmits, to the base station 10, information indicating that the VUE 20a is a terminal that performs V2X communication. In response to this, the base station 10 transmits system information pertaining to V2X communication to the VUE 20a. For example, the system information may include the mapping information depicted in FIG. 9.

The mapping information indicates relations between sidelink control information SL_UCI and attributes of V2X traffic/services. In this example, sidelink control information SL_UCI is expressed by four bits. In this example, the attributes of the V2X traffic/services include communication type, payload size, reliability, minimum communication distance, and latency. Communication type identifies broadcast, groupcast, and unicast. Payload size indicates the size of data transmitted in V2X communication. Reliability indicates a reliability required by the V2X traffic/services. Minimum communication distance indicates a transmission distance required by the V2X traffic/services. Latency (or delay) indicates a permissible value for the time period from the moment at which V2X data is generated to the moment at which the V2X data is received (i.e., end-to-end latency). Other elements that are not indicated in FIG. 9 may be used as attributes for the V2X traffic/services. For example, sidelink control information SL_UCI may be associated with the service quality (QoS) of the V2X traffic/services.

When the VUE 20a has mapping information in advance, the base station 10 does not need to transmit mapping information to the VUE 20a. Mapping information is not limited to the example depicted in FIG. 9, and another piece of information may be allocated to sidelink control information SL_UCI. For example, sidelink control information SL_UCI may indicate a use case of V2X communication (vehicle platooning, advanced driving, extended sensors, remote driving). Alternatively, sidelink control information SL_UCI may indicate scenarios described in 3GPP TS 22.186 V15.2.0 (Table 5.2-1, Table 5.3-1, Table 5.4-1).

When transmitting data via V2X communication, the VUE 20a determines the attributes of the data (i.e., V2X data). For example, the attributes of V2X data may be reported from an application that has generated the V2X data to the controller 21 of the VUE 20a. Meanwhile, the VUE 20a generates sidelink control information SL_UCI based on the attributes of V2X data. In a case where the mapping information depicted in FIG. 9 is used, the VUE 20a determines a value of SL_UCI corresponding to the attributes of V2X data. Then, the VUE 20a transmits sidelink control information SL_UCI to the base station 10. For example, the sidelink control information SL_UCI may be transmitted from the VUE 20a to the base station 10 by using specified resources in a PUCCH. Note that the resource for transmitting sidelink control information SL_UCI is indicated by control information broadcast from the base station to UEs or individual control information (e.g., RRC_DEDICATED).

Upon receipt of the sidelink control information SL_UCI, the base station 10 determines, according to the value of SL_UCI, resources to be allocated to the V2X communication requested by the VUE 20a. In this case, the base station 10 determines resources to be allocated to the requested V2X communication in accordance with, for example, the mapping information depicted in FIG. 9. In particular, resources for the V2X communication are determined so as to satisfy a data size and a maximum latency corresponding to the value of SL_UCI. In this way, sidelink control information SL_UCI is used as resource request information requesting resources for V2X communication.

Subsequently, the base station 10 generates sidelink grant information indicating the resources allocated to the requested V2X communication and transmits the sidelink grant information to the VUE 20a. The sidelink grant information includes information indicating PSSCH resources for transmitting V2X data and information indicating PSCCH resources for transmitting control information for the V2X data. Note that sidelink grant information is an example of resource allocation information indicating resources granted by the base station 10 for D2D communication or sidelink communication. For example, sidelink grant information may be incorporated into downlink control information DCI so as to be transmitted from the base station 10 to the VUE 20a.

The VUE 20a generates a sidelink transport block and control information SCI. The sidelink transport block is generated according to the sidelink grant information. For example, symbols and subcarriers for transmitting the sidelink transport block may be determined according to the sidelink grant information. The V2X data is stored in the sidelink transport block. The control information SCI indicates the arrangement in V2X data (symbols and subcarriers), a modulation scheme, code, and the like. Control information SCI is used when a wireless communication device that has received V2X data decodes the V2X data.

The VUE 20a transmits the V2X data to the VUE 20b by using the resources reported by the sidelink grant information. In this case, the control information SCI is transmitted using the PSCCH designated by the sidelink grant information. Meanwhile, the V2X data is transmitted using the PSSCH designated by the sidelink grant information.

As described above, the wireless communication system in the first embodiment is such that when a VUE 20 transmits sidelink control information SL_UCI to the base station 10, the base station performs resource allocation for V2X communication and transmits sidelink grant information to the VUE 20. Thus, sidelink grant information indicating resources for V2X communication is reported from the base station 10 to the VUE 20 without transmitting a buffer status report BSR from the VUE 20 to the base station 10 via a PUSCH. Accordingly, the first embodiment reduces a latency in transmitting V2X data in comparison with the procedure depicted in FIG. 4.

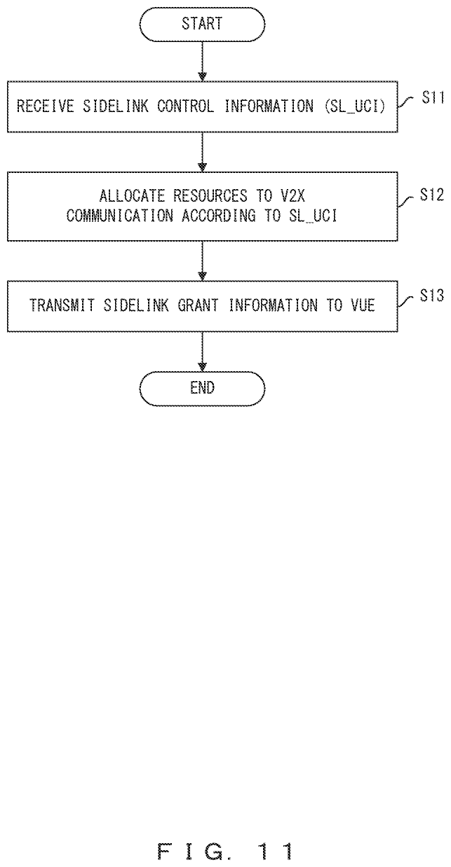

FIG. 10 is a flowchart illustrating an example of processes performed by a VUE. The processes of this flowchart are performed when V2X data from an application arrives at a VUE 20.

In S1, the controller 21 acquires V2X data generated by an application for V2X communication.

In S2, the controller 21 determines values of SL_UCI based on the attributes of the acquired V2X data. For example, when the mapping information depicted in FIG. 9 has been configured for the VUE 20, four bits of SL_UCI may be generated according to the attributes of V2X data. Then, the controller 21 generates sidelink control information SL_UCI including the SL_UCI.

In S3, the radio transmitter 23 transmits the sidelink control information SL_UCI to the base station 10. The sidelink control information SL_UCI is transmitted from the VUE 20 to the base station 10 by using a PUCCH. For example, resources (symbols and subcarriers) for transmitting the sidelink control information SL_UCI may be determined in advance between the base station 10 and the VUE 20. Upon receipt of the sidelink control information SL_UCI, the base station 10 performs resource allocation for V2X communication so as to generate sidelink grant information. The sidelink grant information includes information indicating PSSCH resources for transmitting the V2X data and information indicating PSCCH resources for transmitting control information SCI for the V2X data.

In S4, the radio receiver 24 receives the sidelink grant information transmitted from the base station 10. The sidelink grant information is transmitted from the base station 10 to the VUE 20 by using a PDCCH. For example, resources (symbols and subcarriers) for transmitting the sidelink grant information may be determined in advance between the base station 10 and the VUE 20.

In S5, the radio transmitter 25 transmits the V2X data in accordance with the sidelink grant information. In this case, together with the V2X data, the control information SCI for decoding the V2X data is transmitted. The V2X data is transmitted using the PSSCH resources designated by the sidelink grant information. The control information SCI is transmitted using the PSCCH resources designated by the sidelink grant information. Note that the control information SCI is generated by the controller 21 according to the sidelink grant information.

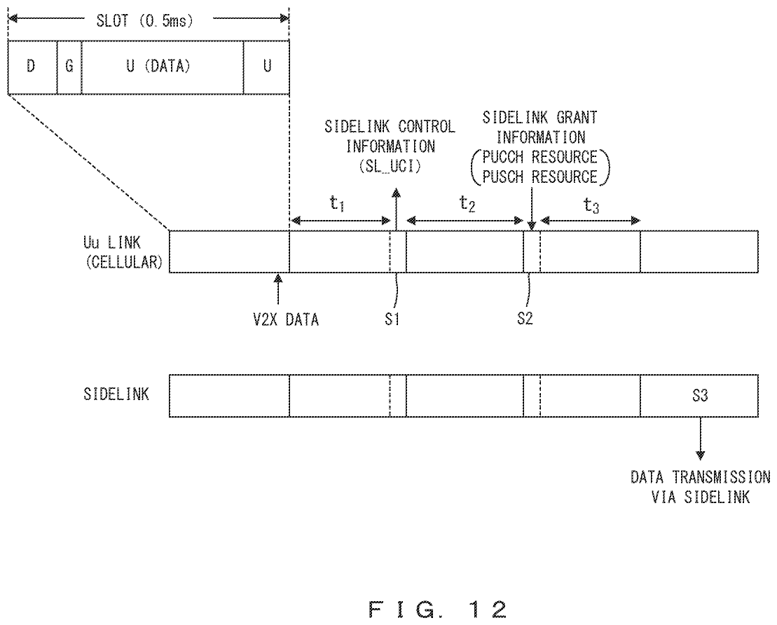

FIG. 11 is a flowchart illustrating an example of processes performed by a base station. The processes of this flowchart are performed by the base station 10 depicted in FIG. 6.

In S11, the radio receiver 15 receives sidelink control information SL_UCI transmitted from a VUE 20. As described above, the sidelink control information SL_UCI is transmitted from the VUE 20 to the base station 10 by using a PUCCH. For example, resources (symbols and subcarriers) for transmitting the sidelink control information SL_UCI may be determined in advance between the base station 10 and the VUE 20.

In S12, the controller 11 performs resource allocation based on the sidelink control information SL_UCI. In this example, the controller 11 manages one or more data resource pools for V2X data and one or more control resource pools for control information SCI for V2X data. Each data resource pool is associated with a respective one of the control resource pools. The controller 11 detects the attributes of V2X data according to the values of SL_UCI so as to estimate the size of the V2X data. The controller 11 selects one resource pool D from the data resource pools in accordance with the attributes of the V2X data and the estimated data size and selects resources for the V2X data from the resource pool D. Meanwhile, the controller 11 selects a control resource pool C corresponding to the resource pool D from the control resource pools and selects resources for the control information SCI from the control resource pool C.

As a result, sidelink grant information is generated. The sidelink grant information includes information indicating PSSCH resources for transmitting the V2X data and information indicating PSCCH resources for transmitting control information SCI for the V2X data.

In S13, the radio transmitter 14 transmits the sidelink grant information to the VUE 20. As described above, the sidelink grant information is transmitted from the base station 10 to the VUE 20 by using a PDCCH. For example, resources (symbols and subcarriers) for transmitting the sidelink grant information may be determined in advance between the base station 10 and the VUE 20.

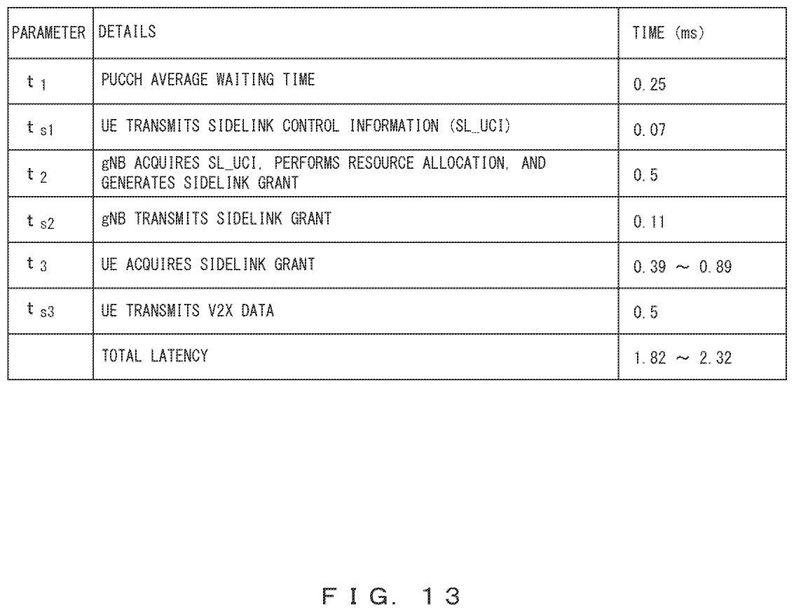

FIG. 12 illustrates an example of the resource allocation in the first embodiment. In this example, the length of each slot is 0.5 milliseconds, as in the example depicted in FIG. 4. Thus, the time domain of each slot is formed from 14 symbols. Three symbols are allocated to a downlink D (data and control information). Eight symbols are allocated to an uplink U (data). Two symbols are allocated to an uplink U (control information). Furthermore, one symbol of guard section G is provided.

Upon V2X data from an application for V2X communication arriving at a VUE 20, the VUE 20 transmits sidelink control information SL_UCI to the base station 10 by using an uplink (PUCCH). In this example, the waiting time for the PUCCH corresponds to the time period from the moment at which the V2X data arrives at the VUE 20 to the moment at which the PUCCH is obtained for the first time after arrival of the V2X data. Thus, an average waiting time t₁ for obtaining PUCCH is ½ of the slot period. Each slot has two symbols allocated to the PUCCH. Thus, a time tₛ₁ needed to transmit the sidelink control information SL_UCI to the base station 10 corresponds to a time needed to transmit two symbols.

The base station 10 performs resource allocation for V2X communication according to the sidelink control information SL_UCI and transmits sidelink grant information to the VUE 20. The sidelink grant information is transmitted from the base station 10 to the VUE 20 by using a downlink (e.g., PDCCH). In this example, three symbols are allocated to the downlink. Thus, a time tₛ₂ needed to receive the sidelink grant information from the base station 10 corresponds to a time needed to transmit three symbols. A period t₂ from the moment at which the sidelink control information SL_UCI is transmitted to the moment at which the sidelink grant information is received is substantially the same as the slot period. During the period t₂, the base station 10 performs resource allocation based on the sidelink control information SL_UCI and generates sidelink grant information.

After receiving the sidelink grant information from the base station 10, the VUE 20 transmits the V2X data at slot s3. Thus, a time tₛ₃ needed to transmit the V2X data is substantially the same as the slot period. Meanwhile, the VUE 20 decodes the sidelink grant information within the period from the moment at which the sidelink grant information is received via the downlink to the time of start of a new slot. Thus, a period t₃ needed to decode the sidelink grant information from the base station 10 corresponds to a time needed to transmit 11 symbols. However, depending on the processing capacity of the VUE 20, one additional slot period may be needed to decode sidelink grant information.

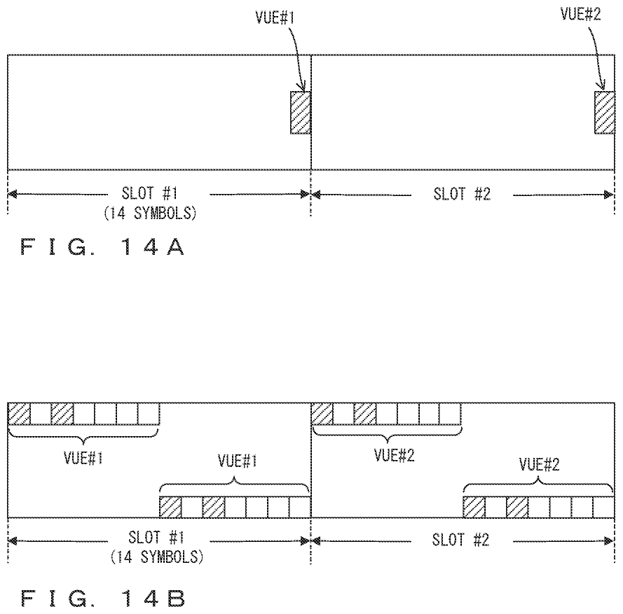

Accordingly, in the example depicted in FIG. 12, the time period from the moment at which V2X data is generated to the moment at which the V2X data is transmitted (i.e., a latency) corresponds to the sum of t₁-t₃ and tₛ₁-tₛ₃ depicted in FIG. 13. In this case, the latency is 1.82-2.32 milliseconds. Thus, the first embodiment reduces the latency in V2X communication to less than 3 milliseconds. Hence, the requirements pertaining to the types of use of 5G V2X services can be satisfied.

In the first embodiment, sidelink control information SL_UCI, not a scheduling request SR, is transmitted from a VUE 20 to the base station 10, in comparison with the procedure depicted in FIG. 4. Meanwhile, the first embodiment does not need the procedure for transmitting a buffer status report BSR. In this regard, the time pertaining to a transmission of a scheduling request SR is substantially the same as a time pertaining to a transmission of sidelink control information SL_UCI. Thus, in comparison with the procedure depicted in FIG. 4, the first embodiment has a reduced time pertaining to a transmission of a buffer status report BSR (including the time needed to determine PUSCH resources for transmitting the buffer status report BSR).

In the example depicted in FIGS. 9-10, sidelink control information SL_UCI expresses the attributes of V2X data with a plurality of bits. However, embodiments of the invention are not limited to this configuration. For example, in a case where V2X data is generated by an application pertaining to services determined in advance or a case in which the size or the like of V2X data to be transmitted is fixed in advance, a VUE 20 does not need to report the attributes of the V2X data to the base station 10. Thus, in these cases, the VUE 20 may request resources for V2X communication by using one bit of sidelink control information SL_UCI. In this case, upon receipt of the sidelink control information SL_UCI, the base station 10 performs resource allocation in accordance with the services determined in advance or the data size determined in advance. Note that parameters pertaining to resource allocation (e.g., data size) may be configured in advance for the base station 10 or reported to the base station 10 from the network management system.

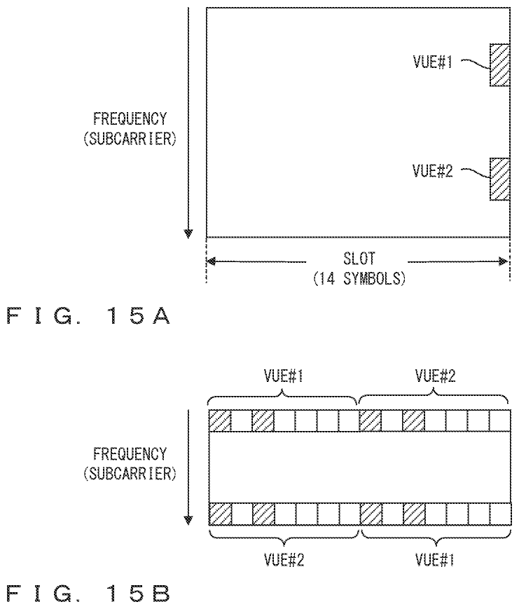

FIGS. 14A-14B and 15A-15B illustrate examples of cases in which a plurality of VUEs each request sidelink communication. Note that when starting sidelink communication, the VUE transmits sidelink control information SL_UCI to the base station 10 by using a PUCCH, as described above.

In the examples depicted in FIGS. 14A and 14B, a plurality of VUEs are multiplexed in a time domain (time division multiplexing). In the example depicted in FIG. 14A, a Short PUCCH format may be used. In the Short PUCCH format, each slot has one or two symbols allocated to a PUCCH. The sidelink control information SL_UCI of VUE #1 is transmitted using the PUCCH in slot #1, and the sidelink control information SL_UCI of VUE #2 is transmitted using the PUCCH in slot #2.

In the example depicted in FIG. 14B, a Long PUCCH format is used. In the Long PUCCH format, each slot has four to fourteen symbols allocated to a PUCCH. In this example, the first to fourteenth symbols in each symbol may be used as a PUCCH. The first to seventh PUCCH symbols are transmitted using a different frequency (i.e., different subcarriers) from the eighth to fourteenth PUCCH symbols. The sidelink control information SL_UCI of VUE #1 is transmitted using the first, third, eighth, and tenth PUCCH symbols in slot #1. Other PUCCH symbols may transmit, for example, demodulation reference signals (DMRSs) or other pieces of uplink control information of VUE #1. For example, DMRSs may be transmitted using the second, fourth, sixth, ninth, eleventh, and thirteenth PUCCH symbols, and SR may be transmitted using the fifth, seventh, twelfth, and fourteenth PUCCH symbols. The sidelink control information SL_UCI of VUE #2 is transmitted using the first, third, eighth, and tenth PUCCH symbols in slot #2. For example, other PUCCH symbols may transmit DMRSs or other pieces of uplink control information of VUE #2.

In the examples depicted in FIGS. 15A and 15B, a plurality of VUEs are multiplexed in a frequency domain (frequency division multiplexing). In the example depicted in FIG. 15A, the Short PUCCH format is used. The sidelink control information SL_UCI of VUE #1 is transmitted using a different frequency (i.e., different subcarriers) from the sidelink control information SL_UCI of VUE #2.

In the example depicted in FIG. 15B, the Long PUCCH format is used. The sidelink control information SL_UCI of VUE #1 is transmitted using a different frequency from the sidelink control information SL_UCI of VUE #2.

With respect to the time division multiplexing and the frequency division multiplexing depicted in FIGS. 14A-14B and 15A-15B, a plurality of VUEs may each transmit corresponding sidelink control information SL_UCI by using a different base sequence of DMRSs.

### Second Embodiment

In the first embodiment, a VUE transmits sidelink control information SL_UCI to the base station immediately after acquiring V2X data. By contrast, in the second embodiment, a VUE selects a sequence for requesting sidelink resources in accordance with a maximum latency required by V2X data.

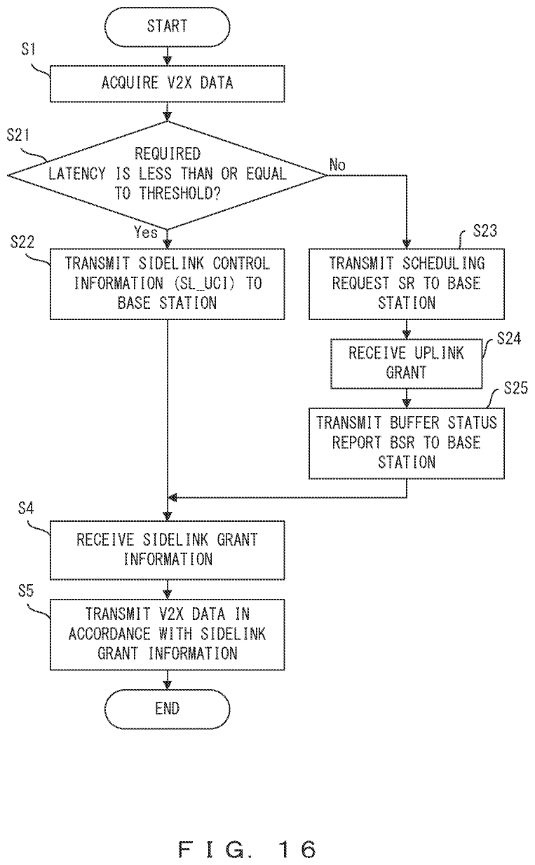

FIG. 16 is a flowchart illustrating an example of processes performed by a VUE in the second embodiment. As in the method depicted in FIG. 10, V2X data from an application for V2X communication arrives at a VUE 20 at S1.

In S21, the controller 21 decides whether a latency required by the V2X data is less than or equal to a threshold. For example, the required latency may be reported from an application. Alternatively, the required latency may be determined in advance for the application for generating V2X data. The threshold may be autonomously determined by the VUE. Meanwhile, the threshold may be indicated by control information broadcast from the base station or individual control information (e.g., RRC_DEDICATED).

When the required latency is less than or equal to the threshold, the controller 21 generates and transmits sidelink control information SL_UCI to the base station 10 in S22. The process of S22 corresponds to S2-S3 depicted in FIG. 10. Thus, upon the VUE 20 performing the process of S22, the base station 10 performs resource allocation in accordance with the sidelink control information SL_UCI and transmits sidelink grant information to the VUE 20.

When the required latency is greater than the threshold, the controller 21 performs the processes of S23-S25. The processes of S23-S25 are realized using a similar procedure to the existing resource allocation method depicted in FIG. 2. In particular, the radio transmitter 23 transmits a scheduling request SR to the base station 10 in S23. In this case, the base station 10 transmits an uplink grant indicating resources for an available uplink in return to the VUE 20. In S24, the VUE 20 receives the uplink grant. Then, the radio transmitter 23 transmits, in S25, a buffer status report BSR to the base station 10 by using the resources designated by the uplink grant. Note that the buffer status report is generated by the controller 21 according to the size or the like of the V2X data.

In this way, the VUE 20 transmits sidelink control information SL_UCI or a buffer status report BSR to the base station 10 according to the maximum latency required by V2X data. In this example, irrespective of which of sidelink control information SL_UCI or a buffer status report BSR is received, the base station 10 can perform resource allocation so as to generate sidelink grant information. The sidelink grant information is transmitted from the base station 10 to the VUE 20. Thus, in S4-S5, the VUE 20 transmits V2X data in accordance with the sidelink grant information.

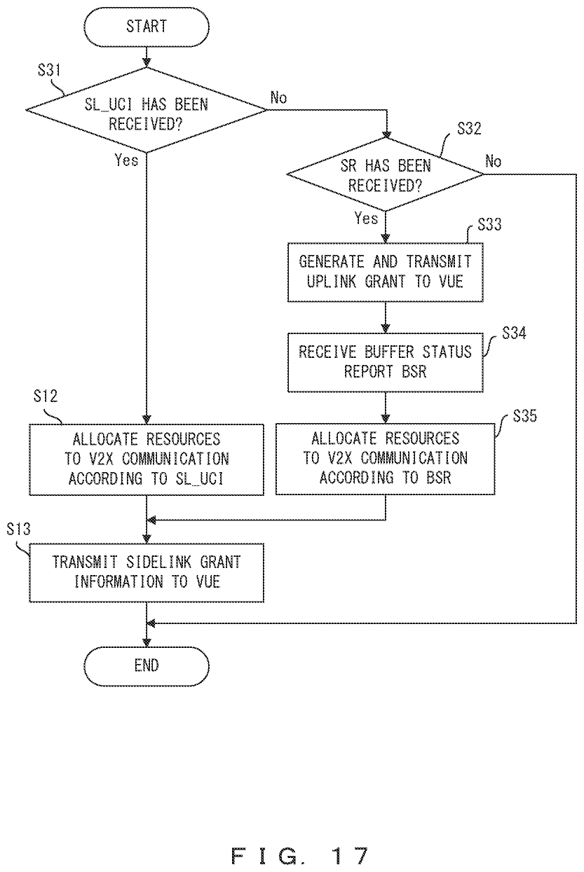

FIG. 17 is a flowchart illustrating an example of processes performed by a base station in the second embodiment. In the processes of this flowchart, sidelink control information SL_UCI or a scheduling request SR is transmitted from a VUE 20 using the method depicted in FIG. 16.

When the radio receiver 15 receives sidelink control information SL_UCI from the VUE 20 (S31: Yes), the base station 10 performs the processes of S12-S13. Thus, in S12, the controller performs resource allocation based on the sidelink control information SL_UCI and generates sidelink grant information. In S13, the radio transmitter 14 transmits the sidelink grant information to the VUE 20.

When the radio receiver 15 receives a scheduling request SR from the VUE 20 (S32: Yes), the radio transmitter 14 transmits an uplink grant to the VUE 20 in S33. In this case, the VUE 20 transmits a buffer status report BSR by using resources designated by the uplink grant. In S34, the radio receiver 15 receives the buffer status report BSR. In S35, the controller 11 performs resource allocation based on the buffer status report BSR and generates sidelink grant information. Then, in S13, the sidelink grant information generated in S35 is transmitted to the VUE 20.

Accordingly, in the second embodiment, when V2X communication with a small maximum latency is requested, sidelink control information SL_UCI is transmitted; otherwise, a scheduling request SR is transmitted. In this regard, both sidelink control information SL_UCI and a scheduling request SR are transmitted via a PUCCH. Thus, assuming that the bit length of sidelink control information SL_UCI is greater than the bit length of scheduling requests SR, overheads on PUCCHs will be larger if sidelink control information SL_UCI is transmitted for all V2X communication. Accordingly, the second embodiment is such that scheduling requests SR are transmitted only for V2X communication that is not accompanied by a strict requirement in terms of latency, thereby reducing overhead on PUCCHs. In the example depicted in FIG. 9, SL_UCI is constituted by four bits. Meanwhile, a scheduling request SR may be constituted by one bit.

In the second embodiment, both sidelink control information SL_UCI and a scheduling request SR may be transmitted from a VUE 20 to the base station 10 by using a PUCCH. Thus, both the sidelink control information SL_UCI and the scheduling request SR may be transmitted using the resources represented by hatched regions indicated in FIGS. 14A, 14B, 15A, or 15B.

### Third Embodiment

5G allows a slot configuration to be dynamically changed. For example, a base station can select a desired slot among a slot of 1 millisecond, a slot of 0.5 milliseconds, and a slot of 0.25 milliseconds. The base station can also select a “mini-slot” having 2-13 symbols. A “mini-slot” may also be referred to as “non-slot based transmission/scheduling.”

In the third embodiment, the slot configuration is dynamically changed in the procedure for allocating resources to V2X communication. Thus, a latency in the procedure for resource allocation for V2X communication can be reduced.

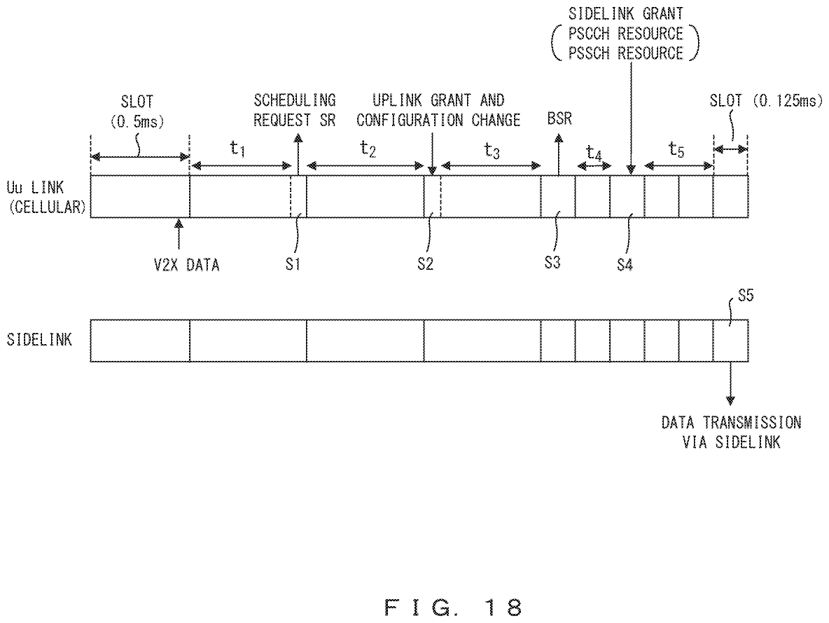

FIG. 18 illustrates an example of the resource allocation in the third embodiment. In the third embodiment, when V2X data is generated, a VUE 20 transmits a scheduling request SR to the base station 10. The scheduling request SR requests resources for uplink through a procedure similar to the procedure for 4G depicted in FIG. 2.

Upon receipt of the scheduling request SR, the base station 10 generates an uplink grant, as in the procedure for 4G depicted in FIG. 2. However, in the third embodiment, configuration change information is generated in addition to the uplink grant. The configuration change information includes an instruction to decrease the slot length. In this example, the configuration change information includes the following information.

Slot length: Slot of 0.5 milliseconds is changed to Mini-slot of 0.125 milliseconds with 7 symbols

### SCS: 60 kHz

### Downlink: 7 Symbols

Guard section: 1 symbol
Uplink (data): 6 Symbols
Uplink (control information): 1 Symbol
The uplink grant and the configuration change information are reported from the base station 10 to the VUE 20 via a PDCCH.

Upon receipt of the configuration change information from the base station 10, the VUE 20 changes the configurations of the subsequent slots. Then, the VUE 20 transmits a buffer status report BSR to the base station 10 by using mini-slot s3. Note that the uplink resources for transmitting the buffer status report BSR to the base station 10 are designated by the above uplink grant.

The base station 10 allocates resources to the requested V2X communication in accordance with the buffer status report BSR. In this case, PSSCH resources for transmitting the V2X data and PSCCH resources for transmitting control information SCI are determined. Subsequently, the base station 10 transmits, to the VUE 20, sidelink grant information indicating the resource allocation.

The VUE 20 receives the sidelink grant information at mini-slot s4. Then, the VUE 20 transmits the V2X data and the control information SCI according to the sidelink grant information. In the example depicted in FIG. 18, V2X data is transmitted via the sidelink at mini-slot s5.

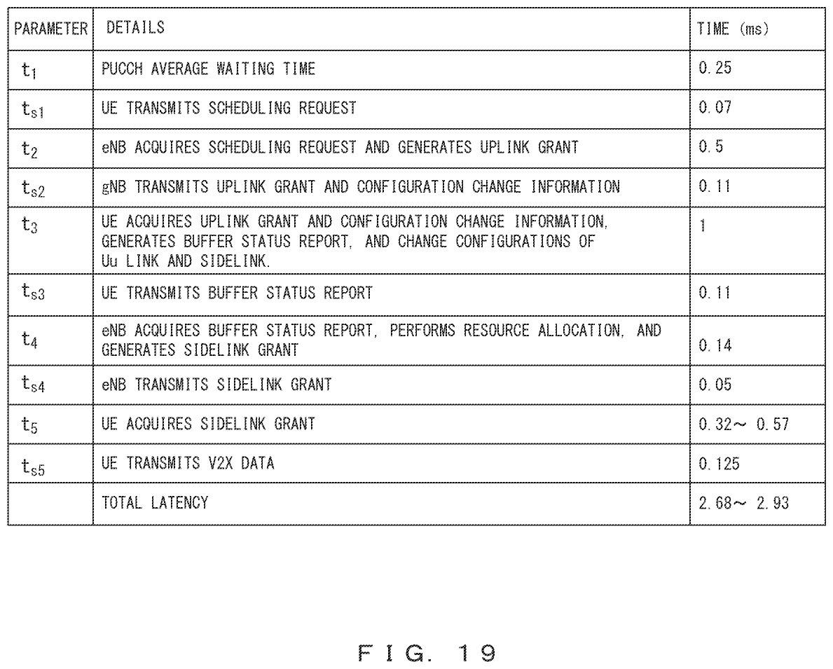

In the third embodiment, the time period from the moment at which V2X data is generated to the moment at which the V2X data is transmitted (i.e., a latency) corresponds to the sum of t₁-t₅ and tₛ₁-tₛ₅ depicted in FIG. 19. In this example, the latency pertaining to the transmission of V2X data is 2.68-2.93 milliseconds.

As described above, the third embodiment is such that the slot configuration is dynamically changed in the procedure for allocating resources to V2X communication. As a result, the third embodiment allows a latency pertaining to resource allocation for V2X communication to be reduced in comparison with the procedure depicted in FIG. 4.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A communication device that supports device-to-device (D2D) communication, the communication device comprising:
a processor configured to generate control information that pertains to D2D data and requests a resource for transmitting the D2D data;
a transmitter configured to transmit the control information to a base station; and
a receiver configured to receive, from the base station, information indicating resource allocation for transmitting the D2D data via D2D communication, wherein
the transmitter transmits the D2D data to a destination device via D2D communication according to the information indicating the resource allocation.

2. The communication device according to claim 1, wherein
the control information indicates an attribute of the D2D data.

3. The communication device according to claim 1, wherein
the processor generates the control information according to at least one of communication type, data size, reliability, minimum communication distance, latency, and Quality of Service.

4. The communication device according to claim 1 wherein
the processor generates the control information according to a latency required for the transmission of the D2D data.

5. The communication device according to claim 1 wherein
the transmitter transmits the control information to the base station when a latency required for the transmission of the D2D data is less than or equal to a specified threshold.

6. The communication device according to claim 5, wherein
when the latency is greater than the threshold, the processor performs the processes for
sending a request for an uplink resource to the base station,
reporting a volume of the D2D data to the base station by using an uplink resource reported from the base station, and
acquiring the information indicating resource allocation for transmitting the D2D fata from the base station.

7. A base station device comprising:
a receiver configured to receive, from a communication device, control information that pertains to device-to-device (D2D) data and requests a resource for transmitting the D2D data via D2D communication;
a processor configured to generate information indicating resource allocation for transmitting the D2D data via D2D communication based on the control information; and
a transmitter configured to transmit the information indicating the resource allocation to the communication device.

8. The base station device according to claim 7, wherein
the control information indicates an attribute of the D2D data, and
the processor generates the information indicating the resource allocation for transmitting the D2D data via D2D communication based on the attribute of the D2D data indicated by the control information.

9. A communication system comprising:
a base station; and
a communication device configured to support device-to-device (D2D) communication, wherein
the communication device generates control information that requests a resource for transmitting D2D data,
the communication device transmits the control information to the base station,
the base station generates information indicating resource allocation for transmitting the D2D data via D2D communication in accordance with the control information,
the base station transmits the information indicating resource allocation to the communication device, and
the communication device transmits the D2D data to a destination device via D2D communication according to the information indicating the resource allocation.

10. The communication system according to claim 9, wherein
the control information indicates an attribute of the D2D data, and
the base station generates information indicating resource allocation for transmitting the D2D data via D2D communication based on the attribute of the D2D data indicated by the control information.

11. The communication system according to claim 9, wherein
the communication device transmits the control information to the base station when a latency required for the transmission of the D2D data is less than or equal to a specified threshold.

12. A communication method for transmitting device-to-device (D2D) data in a communication system provided with a base station and a communication device that supports D2D communication, the communication method comprising:
generating, by the communication device, control information that requests a resource for transmitting D2D data via D2D communication;
transmitting, by the communication device, the control information to the base station;
generating, by the base station, information indicating resource allocation for transmitting the D2D data in accordance with the control information;
transmitting, by the base station, the information indicating the resource allocation to the communication device; and
transmitting, by the communication device, the D2D data to a destination device via D2D communication according to the information indicating the resource allocation.

13. A communication system comprising:
a base station; and
a communication device configured to support device-to-device (D2D) communication, wherein
the communication device transmits control information for requesting an uplink resource to the base station when D2D data is generated,
upon receipt of the control information, the base station transmits, to the communication device, uplink resource information indicating an available uplink resource and configuration change information including an instruction to change a configuration of a slot for transmitting a signal,
the communication device adjusts the configuration of the slot in accordance with the configuration change information,
the communication device reports a volume of the D2D data to the base station by using the resource indicated by the uplink resource information,
the base station generates, according to the volume of the D2D data, information indicating resource allocation for transmitting the D2D data via D2D communication and transmits the generated information to the communication device, and
the communication device transmits the D2D data to a destination device via D2D communication according to the information indicating the resource allocation.
